(19) United States
(12) Patent Application Publication
(10) Pub. No.: US 2018/0053129 A1
(43) Pub. Date: Feb. 22, 2018

(54) LOCAL SERVICE PROVIDING AND SERVICE MATCHMAKING SYSTEM AND METHOD THEREOF

(71) Applicant: ZEROPLUS TECHNOLOGY CO., LTD., New Taipei (TW)

(72) Inventors: Chiu-Hao Cheng, New Taipei (TW); Tien-Yu Wu, Kaohsiung (TW)

(73) Assignee: ZEROPLUS TECHNOLOGY CO., LTD., New Taipei (TW)

(21) Appl. No.: 15/652,159

(22) Filed: Jul. 17, 2017

Related U.S. Application Data
(60) Provisional application No. 62/376,054, filed on Aug. 17, 2016.

(51) Int. Cl. G06Q 10/06; G06Q 20/24; G06Q 50/10

(52) U.S. Cl. CPC G06Q 10/06311; G06Q 50/10; G06Q 20/24

(57) ABSTRACT

A local service providing and service matchmaking system adapted to connect with a plurality of user ends and a method thereof are disclosed. The system includes a processing module; a communication module adapted to communicate with the plurality of user ends to receive or respond to the information or a service request uploaded by the plurality of user ends; a database, adapted to store the information; a matchmaking platform, adapted to match the service request with the information stored in the database and generate a matching result, and a task platform, adapted to publish at least one task based on the service request, wherein the at least one task can be selected by the at least one of the plurality of user ends registered as a helper to meet the service request, and the helper is rewarded after completing the at least one task.

### BACKGROUND OF THE INVENTION

### 1. Technical Field

The present invention is related to service providing and service matchmaking, and more particularly to a local service providing and service matchmaking system and a method thereof.

### 2. Description of Related Art

With the rapid development and popularization of the Internet, new types of electronic commerce and consumption models for purchasing goods or providing services are mushrooming.

However, most of the current consumption models are confined to the interactions conducted between the buyers and the sellers. Sometimes the transactions between the buyers and the sellers fail due to the limited information, lack of resource, or being lower than a predetermined consumption threshold, and the transaction opportunity is gone.

For example, in an activity of group buy, a predetermined threshold which has to be met to obtain a special price provided by the sellers is usually set to the activity. However, when the purchasing amount of the buyers is lower than the threshold of the activity, the special price cannot be obtained and the buyers usually give up their willing to buy the products. Meanwhile, the sellers also lose the opportunity of selling the products.

In another example, for one case that a large delivery order is submitted to a store, unfortunately the store is not able to take the order due to insufficient manpower. Hence, the store has to refuse the order and it is a pity for the store to lose the business income.

### BRIEF SUMMARY OF THE INVENTION

In view of the above, the present invention is to provide a local service providing and service matchmaking system and a method thereof. The system not only includes a matchmaking platform for matching the supply and demand between the sellers and buyers, but also includes a task platform adapted to solicit a helper to meet a service request generated between the sellers and the buyers so as to promote the transaction.

The present invention provides A local service providing and service matchmaking system, adapted to connect with a plurality of user ends, which includes a processing module; a communication module, connected to the processing module and adapted to communicate with the plurality of user ends to receive or respond to the information or a service request uploaded by the plurality of user ends; a database, connected to the processing module and adapted to store the information received by the communication module; a matchmaking platform, connected to the processing module and adapted to match the service request uploaded by one of the plurality of user ends with the information stored in the database so as to generate and respond a matching result to the at least one of the plurality user ends; and a task platform, connected to the processing module and adapted to publish at least one task based on the service request uploaded by the at least one of the plurality of user ends, wherein the at least one task can be selected by the at least one of the plurality of user ends registered as a helper to meet the service request, and the helper is rewarded after completing the at least one task.

The present invention also provides a method for providing local service and service matchmaking, which includes steps of: receiving and storing information uploaded from a plurality of user ends in a database; providing a matchmaking platform adapted to receive a service request uploaded by at least one of the plurality of user ends, and match the service request and the information stored in the database so as to generate and respond a matching result to the at least one of the plurality user ends; providing a task platform adapted to receive the service request uploaded by the at least one of the plurality of user ends, and publish at least one task according to the service request; receiving a selection of the at least one task from the at least one of the plurality of helpers registered as a helper, and rewarding the helper after the service request of the at least one task being met by the helper.

The advantage of the present invention is that the service request submitted by the user end can be matched with the information stored in the database via the matchmaking platform and a matching result can be obtained. Moreover, a task according to the request service of the user ends can be published via the task platform which can solicit a helper to meet the service request to promote the transaction.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a structure diagram of the server end of the local service providing and service matchmaking system of an embodiment of the present invention;

FIG. 2 is a structure diagram of the local service providing and service matchmaking system of the embodiment of the present invention;

FIG. 3 is a schematic view, showing an electronic device retrieves a corresponding image of the menu by taking a picture of the menu;

FIG. 4 is a schematic view, showing the screen of the electronic device displays a virtual menu;

FIG. 5 is a schematic view, showing the screen of the electronic device displays a virtual menu; and

FIG. 6 is a schematic view, showing the searching region of a helper of the present invention.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

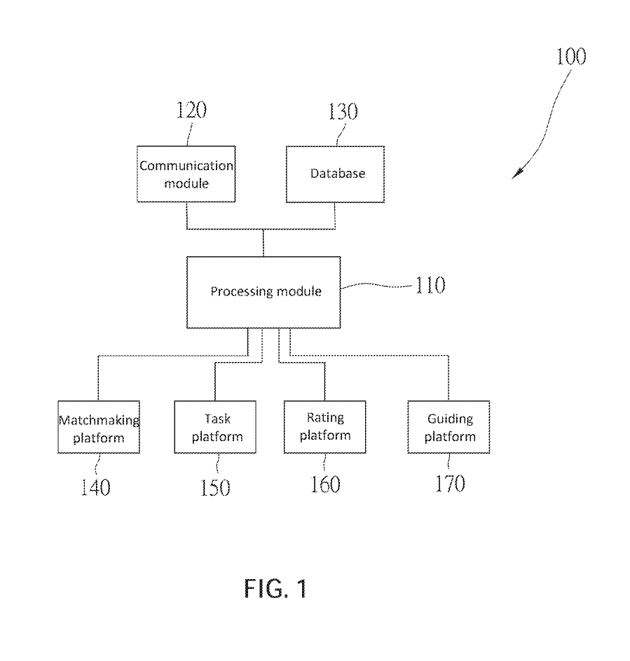

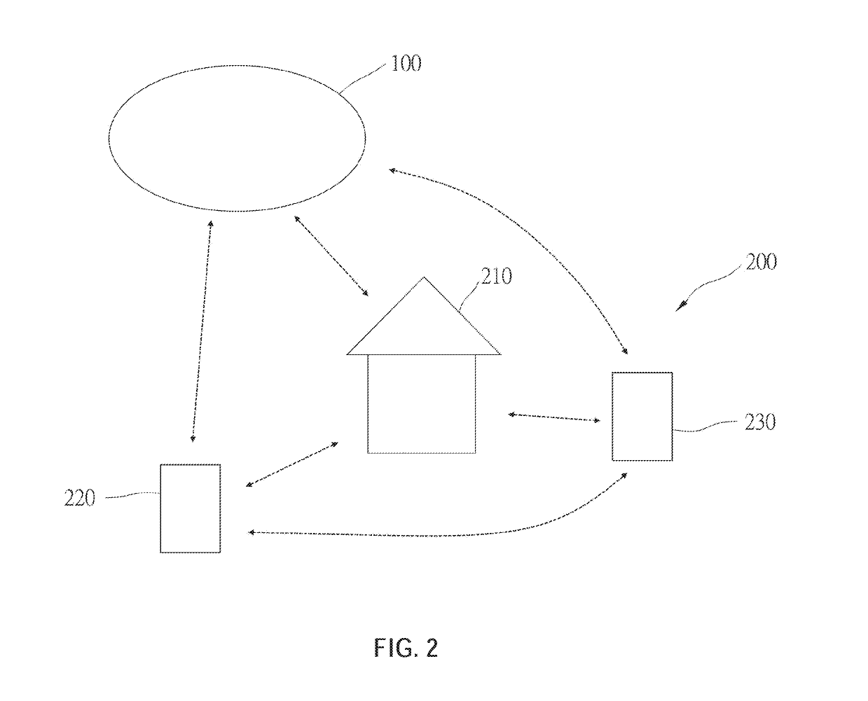

A local service providing and service matchmaking system of an embodiment of the present invention is illustrated in FIG. 1 to FIG. 3, wherein the system includes a server end 100 and a plurality of user ends 200.

The server end 100 includes a processing module 110, a communication module 120, a database 130, and an application having a matchmaking platform (or called a matchmaking system) 140, a task platform (or called a task system) 150, and a rating platform (or called a rating system) 160 established therein. The processing module 110 is adapted to communicate with the aforementioned modules through wired or wireless ways, whereby the corresponding modules and platforms could be controlled to perform operations. However, the ways of communication are not limitations of the present invention, the communication between said processing module 110 and said modules could be also realized through electrical connections of physical signal wires. In addition, said platforms could also communicate with each other through wired or wireless ways.

The communication module 120 is adapted to communicate through wired or wireless ways (e.g., wireless network, Bluetooth, Wi-Fi, 3G or 4G mobile telecommunications, etc.), and therefore could receive and respond the requests from the user ends 200. The database 130 is adapted to store and memory multiple pieces of data, wherein said data includes the data of the server end 100 and the data of the user ends 200.

Based on the request and/or the condition submitted by at least one of the user ends 200 (e.g., a first user end), the matchmaking platform 140 could correspondingly select one of the user ends 200 (e.g., a second user end) or a plurality user ends 200 by matchmaking and matching and generate a matching result. Furthermore, if none of the user ends 200 matches the request and/or the condition submitted by the first user end, the result of selection could be also not available. In such a condition, the server end 100 could remind the first user end to reset a command, such as resetting a request and/or a condition, through the communication module 120.

The task platform 150 is adapted to let each of the user ends 200 to publish a task, wherein each of the user ends 200 could browse the tasks published by other user ends 200 on the task platform 150, and each of the user ends 200 could take any tasks published by other user ends 200. When any of the user ends 200 completes the task it took to meet the service request, said user end 200 could receive a corresponding payment or reward.

The rating platform 160 is adapted to deal with the ratings and relevant comments of any one of the user ends 200 to other user ends 200.

Said user ends 200 includes at least one electronic device, which could be a smartphone, a tablet, a laptop, a desktop computer, etc., or a wearable electronic device such as a smart watch, smart glasses, or a smart contact lens. However, the above enumerations are not limitations of the present invention. Said electronic device could be used to communicate with the aforementioned server end 100 through a communication component thereof in a wireless manner (e.g., through a wireless network, Bluetooth, Wi-Fi, 3G or 4G mobile telecommunications, etc.). Said electronic device could further includes a GPS module, which could retrieve a position data of the device.

A user could register to the server end 100 through the electronic device. After the registration is completed, a user could optionally choose to at least become a shop (a seller) 210, a buyer 220, and a helper 230. In other words, a user could be the shop 210, the buyer 220, and the helper 230 at the same time. Said shop 210 broadly refers to any service provider or product seller; said buyer 220 broadly refers to anyone who purchases the products or services provided by the shop 210; said helper 230 broadly refers to anyone who takes any task displayed on the task platform, and completes the task to receive corresponding payments.

In an embodiment, as a seller, the user could use the electronic device to register a shop 210, which is a restaurant as an example, to the server end 100. To improve the willing to use the local service providing and service matchmaking system, and to encourage users to actively register as the shop 210, the user could be given preferential treatment to open their first shop. For example, opening a first shop could be free of charge to encourage users to join the system. Also, in another embodiment, opening a second or more shops may require adequate rent, wherein said rent could be paid through virtual currency exclusively belonged to the local service providing and service matchmaking system. In addition, the virtual currency could be only used to pay the services provided by the server end 100; the payments for the tradings between the buyers 220 and the shops 210 could be made in different ways agreed by the participants, and the server end 100 would not deal with the payments for selling/buying services or products therebetween.

A user could upload information related to the owned shop 210 to the database 130 of the server end 100, such as photos, address (physical address or GPS location), contacts, menu, prices of products, opening hours, membership information, activity information, publication, promotion information, rules in shop, etc., wherein the information could be browsed by other users. In addition, the user of the shop 210 could create a chatroom exclusively belonged to the shop 210 in the database 130 of the server end 100, whereby the buyers 220 who join the chatroom could interact with the shop 210 to inquiry menus, check reservation, request shop introduction, and so on. Furthermore, the buyer 220 could also upload photos and videos to the chatroom; the shop 210 would have the permission to delete the content in the aforementioned chatroom. Also, in another embodiment, there could be the function of instant messaging, which would allow the buyers and the sellers to communicate and contact with each other. Moreover, in another embodiment, before uploading information (such as menu, opening hours, etc.) to be browsed by other users, the shop 210 would be required to pay a certain amount of virtual currency.

On the other hand, a user could also use the electronic device to register to the server end 100, becoming a buyer 220. After the registration, the user could connect to the server end 100 as the buyer 220 through the electronic device, so as to browse the information of other registered shops. Furthermore, the user could also set conditions and requirements for looking up shops. With the corresponding data retrieved from the database 130 through the matchmaking platform 140, the matchmaking and matching between the buyers and the shops could be performed. Said conditions and requirements (or request) could be keywords such as “Chinese cuisine”, “American food”, “French cuisine”, “Italian cuisine”, etc. Or, the keywords could be “cooked rice”, “noodles”, “snacks”, etc. However, the above examples are not limitations of the present invention. Said conditions and requirements are different according to the classifications that the users search in the local service providing and service matchmaking system. For example, if a user intends to search clothes shops, the keywords could be “top”, “pants”, “long sleeve”, “short sleeve”, etc., which are not limited by the above examples. In other words, the searching conditions, keywords, and requirements are correspondingly different in various classifications.

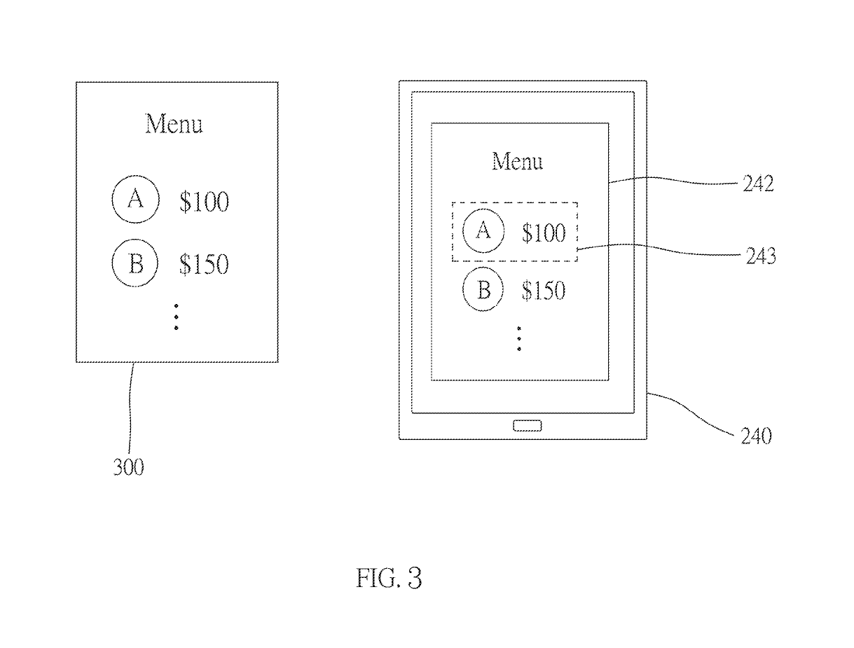

Furthermore, in an embodiment, the seller could open a shop instantly by taking photos. As shown in FIG. 3, a user (e.g., a shop) could use the electronic device 240 to take a picture of a menu 300 (a sheet), generating a menu image 242 (sheet image) corresponding to the menu 300. Whereby, the user could select a predetermined area 243 containing the products for sale from the menu image 242, and the captured image could be directly uploaded to sell the products online. The process of adding products online for sale would be quick and convenient in this way.

In an embodiment, a user could upload the menu image 242 to the server end 100, and store it in the database 130 thereof. After uploading the menu image 242, the processing module 110 of the server end 100 could identify the menu image 242 through an image identification module, and obtain the corresponding meal information according to the information on the menu image 242 or the meal information in the database 130 uploaded by the user in advance. Said meal information would include names of the meals, nutrition facts, time for preparing the meals, etc. Said image identification module could identify the text or numbers on the menu image 242. Furthermore, if the menu image 242 includes images of meals with/without the names of the meals, the processing module 110 could also identify the meal image through the image identification module by searching and comparing the data stored in the database or through Internet. Whereby, the names and/or contents corresponding to the meal image could be identified along with information such as nutrition facts thereof, which enhances the convenience and flexibility for users to upload menus. Consider a situation that a buyer only has an image of one product without knowing the name of the product, the convenience for searching the product could be significantly increased in this way.

Also, the aforementioned meal information could be provided to other users (e.g., other buyers) for reference. When one of other users connects to the server end 100 to check out said meal information, the processing module 110 of the server end 100 could also estimate a waiting time for the user's reference based on the information such as the number of orderings, the number of people waiting there, the cooking time of meals, etc.

In addition, if a user only intends to upload one specific or several specific meals on the menu 300 to the database 130 of the server end 100, the menu image 242 could be edited through the electronic device 240. For example, by selecting a predetermined area 243 on the menu image 242, specific meal information (e.g., the meal information contained in the predetermined area 243) could be uploaded to the database 130. For example, in the current embodiment, the predetermined area 243 contains the information of a meal A, but does not contain the information of a meal B. Therefore, when a user uploads the information contained in the predetermined area 243 of the menu image 242, only the information of the meal A would be uploaded or updated; on the contrary, the information of the meal B would not be uploaded or updated. Whereby, if another seller intends to put the same product online, the corresponding information stored in the database 130 could be displayed as the corresponding information of the product simply by inputting keywords of the names of the products, which facilitates the process of adding products online.

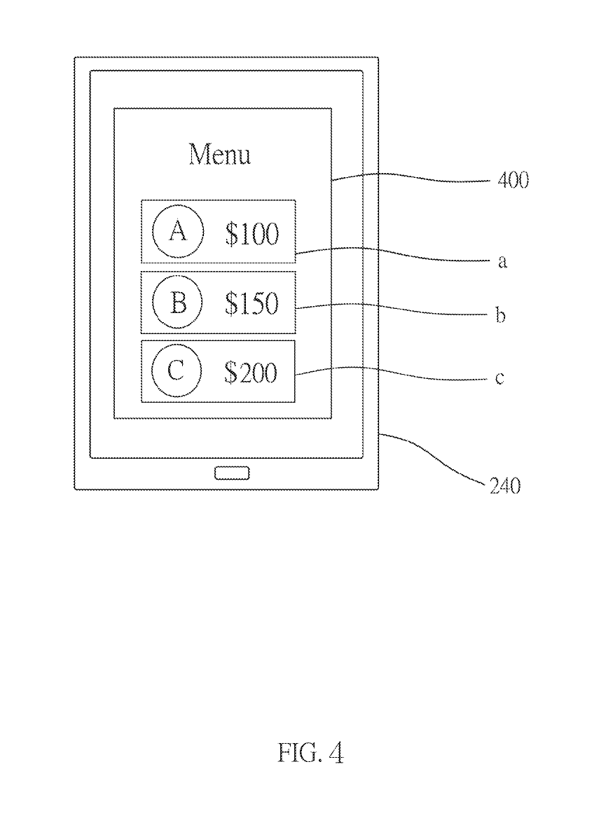

In an embodiment, after a user takes a picture of the menu through the electronic device to generate the menu image corresponding to the menu, and uploads the menu image to the database 130 of the server end 100, the processing module 110 could create a virtual menu corresponding to the menu image, wherein the virtual menu could be browsed by any buyer who connects to the database 130, whereby the user could then order meals according to the virtual menu. It is worth mentioning that, as shown in FIG. 4, which is a schematic view showing that the screen of the electronic device 240 displays a virtual menu 400, wherein each meal (e.g., the meal A, the meal B, a meal C, etc.) on the virtual menu 400 corresponds to a virtual key (e.g. virtual keys a-c), and each of the virtual keys is connected to the corresponding meal (an object) and the menu information in the database 130 created by the shop. When a user clicks one of the virtual keys, the electronic device 240 would send out an order request to the database at the server end which corresponds to the shop. For example, if a user wants to order the meal A, then the user could simply click the virtual key a of the virtual menu 400 displayed on the screen, whereby the request for ordering the meal A could be sent to the shop through the electronic device.

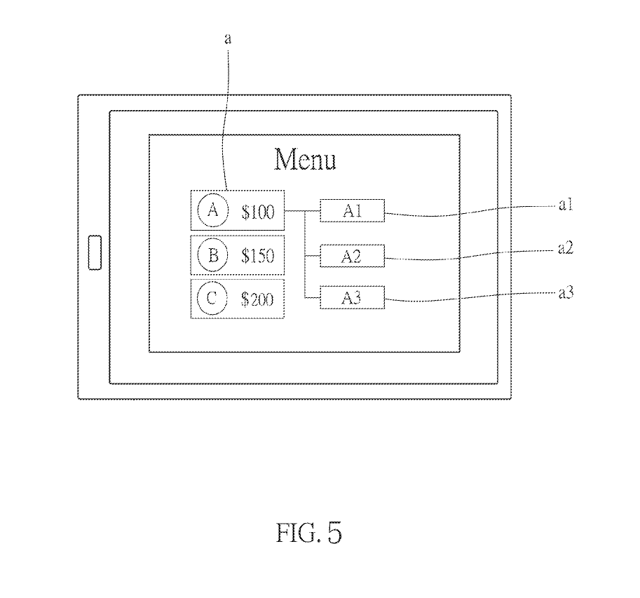

In an embodiment, as shown in FIG. 5, if the meal A selected by the user further contains other detailed options or items to be selected or added, then the virtual menu on the screen would further reveal virtual keys a1-a3 which respectively correspond to other detailed options or items after the user clicks the virtual key a. For example, if the meal A is steak, then said detailed options could be the level of cooking, the portion of beef, the sauce which the steak is served with, etc., or there would be various types of drinks to be selected. The above examples are, of course, not limitations of the present invention. Whereby, by clicking the virtual keys a1-a3, a user could send out an order request to the database at the server end, which corresponds to the shop, to further select or add other items. Whereby, an eco-friendly and paperless ordering mode could be realized, and the process of ordering meals could be completed quickly.

In addition, the present invention is mainly related to a method of matchmaking within a specific area (i.e., region), wherein the buyers 220 and the shops 210 could be confined as all in a specific region (i.e., to have a common locality), whereby each of the buyers 220 could purchase products or services according to the list of classifications of products or services within a specific region. For example, if a user (i.e., the buyer 220) intends to look up shops 210 or services within a specific region, they could turn on the positioning function of the GPS module on their electronic device, and set a certain distance as the diameter of a searching region, whereby the shops 210 located within the searching area and the services provided by those shops 210 could be listed, wherein said distance could be optionally set as X meters, Y kilometer, Z kilometers, and so on, which is not a limitation of the present invention. More specifically, the shops 210 located in the set region would be listed on the electronic device of the buyer 220 to be browsed and viewed by the buyer 220. In addition, the buyer 220 could also check the current business condition of the shops 210. For example, in the current embodiment, the number of people on the site of each of the shops 210 could be known, and the information about whether there are seats available, the time required for waiting for available seats, and the condition of reservation could be also realized. Whereby, the buyer 220 could decide whether to make a reservation or to pre-order meals according to the requirements thereof.

It is worth mentioning that, in the present invention, said locality could be appropriately extended based on the requirements between both sides of the buyer and the seller. For example, say one of the shops 210 provides a promotion similar to group buy, if the number of the buyers 220 in the original region or their total amount of spending are not sufficient to reach a discount threshold set by the shop 210, each of the buyers 220 could spread the news about the promotion of the shop 210 in a moving region thereof to solicit other user ends to join the group buy after obtaining the permission of the shop 210. It is also worth mentioning that, even if the buyers 220 have left the region set by the shop 210, in order to raise sufficient amount for the discount of group buy, they could still propagate the products they are interested in outside the region set by the shop 210. In addition, a buyer could also notify members on the friend list through the communication module 120 at the server end 100 to inquiry if there is any need for shopping. In this way, the goal of organizing a group buy could be quickly achieved.

Also, the extension of said locality with certain restrictions could be done in an alternative way. For example, say one of the buyers 220 makes public a demand for purchasing a product (i.e., a merchandise), if one of the shops 210 sees the demand while in the local region of said buyer 220, and said shop 210 happens to want to visit another region where the product is available, though the another region is not within the local region of said buyer 220, said shop 210 still could ask said buyer 220 if they need said shop 210 to buy the product for them. In this way, the demand for buying the product could be spread out of the locality set by the buyer 220.

When one of the buyers 220 consumes in one of the shops 210 and accepts the service or buys a product from there, said buyer 220 could use the electronic device to record information such as the experience of accepting the service or buying the product this time, and said information could be uploaded to the database 130 to be stored therein, which could be used as a reference for other users who visit the shop 210. In addition, each of the shops 210 could also request the server end 100 to provide the information and ratings thereof in the database 130 left by the buyers 220. Alternatively, the information and ratings could be also actively provided to each of the shops 210 by the server end 100. In the current embodiment, each of the buyers 220 could record and rate the tastes of the meals they have tasted, and each of the shops could have feedbacks from the ratings of the taste of each meal, wherein said ratings are made by the buyers 220. Whereby, the shops 210 could properly adjust the tastes of the meals thereof based on the ratings. It is worth mentioning that, when one of the buyers 220 visit the same shop 210 again, the buyer 220 could be reminded about the meals which had been ordered last time through the information regarding to the tastes and the ratings recorded by them at the previous time, whereby the buyer 220 could appropriately select or adjust the meals to order this time. Furthermore, the shop 210 could customize meals according to the tastes and ratings previously left by the buyer 220, or develop new meals based on the comment feedbacked by the buyer 220. In an embodiment, the shops 210 could list the calories for each meal in advance. Whereby, while ordering, any one of the buyers 220 who intends to control the energy intake could order meals more conveniently since the calories contained in each of the meals are clearly listed. Once one of the shops 210 has inputted the calories of each meal they provide, the related data would be stored in the database 130 of the server end 100, whereby the data could be also referred by other shops 210 to be the information for opening a shop. With the uploaded data regarding calories, any one of the buyers 220 could adjust the amount of each meal based on the calories, which would be convenient for consumers who want to enjoy food without eating too much. Also, a user could use the system to record the total amount of intake calories per week or per month (the time interval could be determined by the user on their own), whereby the purpose of controlling diet could be accomplished.

It is also worth mentioning that, after any buyer 220 completes a trading, the corresponding shop 210 could rate the buyer 220 in the system. For example, said rating could be: (1) welcomed, where additional virtual currency could be given to the buyer 220 to enhance the good feeling between the buyer and the seller, which would encourage the buyer 220 to visit again; (2) unwelcomed, where the buyer 220 would be further noted as an unwelcomed customer or added to a block list, which prevents the buyer 220 from getting any information related to the shop 210 through the system. For example, an unwelcomed customer would not no longer be able to make a reservation, order goods, or book services, etc. In an embodiment, before a seller rating one of the buyers 220, a certain amount of virtual currency might be paid to the server end 100 to activate the function of rating. Said rating could be uploaded to the database 130 of the server end 100 to be stored therein.

Also, said server end 100 further includes a member system, and each of the shops 210 could establish and activate a member system exclusively belonged to the shop 210 at the server end 100, wherein such operation would be free of charge, or require a certain amount of payment. Each of the shops 210 could invite the buyers 220 to join the membership thereof. And once any one of the buyers 220 has become a member of one of the shops 210, the processing module 110 could create a member profile which is exclusively belonged to said buyer 220 in the database 130, and said member could enjoy exclusive promotions designed by said shop 210. In an embodiment, said database 130 further includes a membership level system, which includes a membership level and an experience value of membership level for each member of one of the shops, wherein the experience value of membership level is a basis for determining whether to level up the membership level of a member. For example, when a member shops in the corresponding shop 210, the accumulated amount of spending of said member would be uploaded to the database 130 altogether, and said member would receive corresponding experience points in the membership level system, wherein the experience points would be added to the experience value in the database 130 corresponding to said member. Once the experience value of said member stored in the database reaches a certain threshold, the processing module 110 would accordingly adjust the membership level of said member in the database 130. For example, if the accumulated experience value of a member is between 1-99 units of experience, the membership level thereof could be level 1, wherein said member would be allowed to hold a membership card (e.g., a green card) which could be used to identify the membership level thereof; if the accumulated experience value of said member is between 100-299 units of experience, the membership level thereof would be raised to level 2, wherein the membership card held by said member could be replaced by a silver card; if the accumulated experience value of said member is between 300-599 units of experience, the membership level thereof would be raised to level 3, wherein the membership card held by said member could be replaced by a gold card; if the accumulated experience value of said member is between 600-999 units of experience, the membership level thereof would be raised to level 4, wherein the membership card held by said member could be replaced by a diamond card. Members holding different cards would enjoy different promotions or discounts. For example, a green card member could enjoy a discount of two percent, a silver card member could enjoy a discount of five percent, a gold card member could enjoy a discount of ten percent, and a diamond card member could enjoy a discount of fifteen percent. However, the above examples are not limitations of the present invention. In an embodiment, there could be also employee cards for employees to enjoy exclusive promotions, and VIP cards for VIPs. In addition, each membership card could have a validity period, and the qualification of owning such a membership card in the next quarter or the next year could be determined according to whether the amount of spending in the current quarter or the current year reaches a predetermined threshold. The data in the member system and the membership level system could be stored in the database 130 of the server end 100.

In addition, any one of the shops 210 could also inform each member thereof about an exclusive promotion, such as a birthday promotion. Or, any one of the shops 210 could retrieve a purchase history of a member thereof from the server end in advance, whereby said shop 210 could reckon products or services which said member might be interested in according to the purchase history, which would increase the chances of concluding a trading therebetween.

Also, the purchase history of one of the buyers 220 in one of the shops 210 could be also stored in the database 130 of the server end 100, whereby an exclusive personal bill could be generated to be viewed by said buyer 220. With the personal bill, the purchase habits of said buyer 220 could be classified into different domains. By doing this, said buyer 220 could be more aware of the purchase habits thereof. Moreover, the personal bill could be further divided into a selling part and a buying part, which could be respectively used for generating buying and selling rankings as references of trading relations run by the users.

It is also worth mentioning that, when one of the buyers 220 selects a product or a service of one of the shops 210, and needs a delivery service, part of the shops 210 might not have sufficient manpower for delivery. For example, there might be multiple delivery requests at the same time in rush hours, or the delivery distance might be too far to reach for certain shops 210. In such cases, the hard-won trading opportunities might be lost without the additional manpower to provide the delivery service. In other situations, some delivery requests might be temporal or have a validity period, and part of the shops 210 might not be able to complete the delivery in time. In practice, part of the shops 210 might not even provide a delivery service, but some buyers 220 might not be able to pick up products on their own. To solve the problems above, any one of the shops 210 or any one of the buyers 220 could connect to the task platform 150 at the server end 100 to publish a task, where a corresponding reward could be provided to attract any one of the helpers 230 to take and to complete the task. Furthermore, once one of the helpers 230 completes the task, said helper 230 could be rated. In addition, if deception or other illegal behaviors are found during rating, said helper 230 would be suspended, and relevant authorities would be notified to tackle the issue.

For example, in the current embodiment, any one of the shops 210 could connect to the task platform 150 to publish a task for delivery service, and set related information such as the locations of the origin and the destination of delivery, introductions of the products to be delivered, a designated delivery time and period, rewards to be provided, required level of the helpers, experience points of helper level to receive after the task is completed, etc.

In addition, any one of the buyers 220 could also connect to the task platform 150 to publish a task for delivery service, and to set related information as mentioned above for the task published by any one of the shops 210. In this way, said buyer 220 could ask for assistance from the helpers 230.

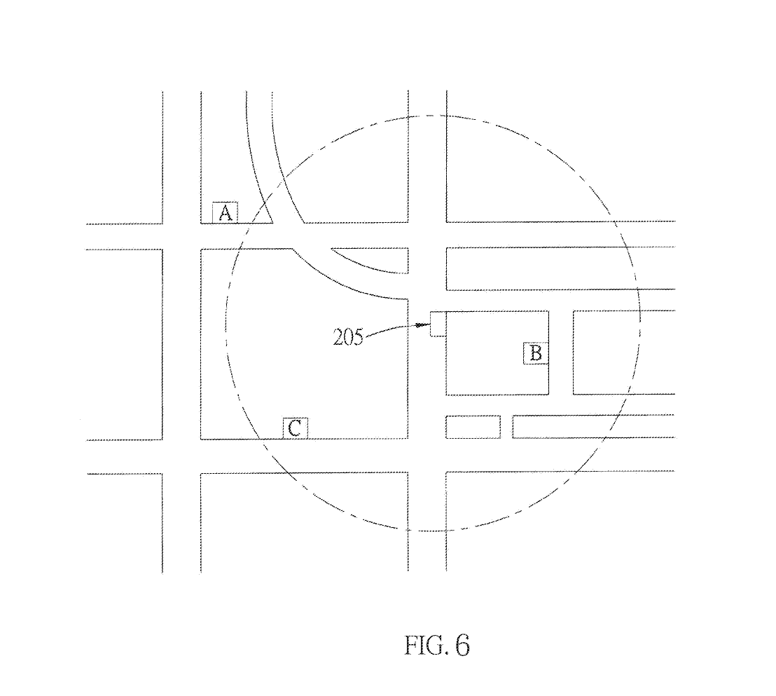

In the database 130 at the server end 100, helper levels and experience values of helper level corresponding to the users are also stored, wherein the experience value is a basis for determining whether each of the helpers 230 should be leveled up. For example, a user who has just registered at the server end 100 as one of the helpers 230 would be level 1 for the helper level thereof, and the experience value of helper level would be zero. As shown in FIG. 6, in an embodiment, as a level 1 helper 230, after such a user connects to the server end 100 through the electronic device, the searching region of said user would be a circle, of which a center would be the electronic device 205 held by said user (i.e., the helper 230), and a diameter would be X meters. Not every task in the database 130 of the server end 100 could be searched, but only those located within the searching region (i.e., said circle) could. In other words, said helper 230 could only see the tasks published by the shop B and the shop C, and the tasks of the shop A would be not visible for said helper 230. With more tasks completed by said helper 230, the experience value of helper level of said helper 230 would be gradually accumulated in the database 130, whereby the helper level of said helper 230 would be raised as well. For example, a level 1 helper 230 could be leveled up to level 2, and so on. Once the helper level of any one of the helpers 230 increases, said helper 230 would be able to take tasks in more classifications, and the searching region for tasks could be further broadened. For example, every time said helper 230 is leveled up, the searching region for tasks could be increased by N meters. In this way, the searching region would become larger, and therefore more tasks could be searched. As a result, the opportunity for receiving more experience points and more virtual currency, or the opportunity for providing more services would become higher as well. The records related to the aforementioned helper levels, task takings, and the completion of tasks are stored in the database 130 of the server end 100.

In addition, after a task is completed, the publisher of said task (e.g., one of the buyers 220 or one of the shops 210) and the helper 230 who accomplishes said task could establish a friendship in the system. Afterward, when there are new tasks being published, the helpers 230 in the friend list would have the priority to be notified of the news first. Whereby, the trust and understanding for cooperation between both sides would be improved. As a result, the completion rate of the tasks could be increased, which facilitates the willing for users to use the local service providing and service matchmaking system.

As mentioned above, with the assistance of a third party (i.e., the helpers 230), the trading between sellers and buyers could be successfully facilitated. With such working model, the cost and risk of delivery for each of the shops 210 could be reduced. Furthermore, the rate of making trades for each of the shops 210 could be enhanced, which would increase additional economics benefits. In addition, the transport vehicle used by any one of said helpers 230 could be a scooter, a bicycle, a motorbike, an automobile, a boat, or an aircraft, which is not a limitation of the present invention. In addition, any one of the helpers 230 could complete the task by walking. In an embodiment, said helpers 230 could also include a taxi driver. In this way, said taxi driver could take a task of delivery in their spare time when there is no passenger, which enhances the economics benefits thereof. As a result, the shops 210, the buyers 220, and the helpers 230 would be all benefited.

It is worth mentioning that, in addition to the aforementioned basic ratings and records, the local service providing and service matchmaking system of the present invention further provides a new form of rating platform 160. As one of the buyers 220, after buying a product or a service from one of the shops 210, or after one of the helpers 230 completing a task, a use permission of the rating platform 160 could be obtained by paying a certain amount of virtual currency, whereby said buyer 220 could rate said shop 210 through the rating platform 160. In addition, in the database 130, critic levels and experience values of critic level corresponding to the users are also stored, wherein the experience value is a basis for determining whether to level up the critic level of each of the users. When a user publishes a rating in a certain domain, the processing module 110 would accumulate the experience value of critic level in the certain domain for said user in the database 130. Once the experience value reaches a predetermined threshold, the critic level in the domain corresponding to said user would be raised in the database. For example, an initial level food critic could be raised to become a middle level, a high level, or even an expert level food critic. However, the examples are not limitations of the present invention. In addition, the domain of restaurant could be further classified into different domains, such as Chinese cuisine restaurant, western cuisine restaurant, Thai cuisine restaurant, etc. Or said domain could be classified by the types of the food. For example, it could be classified into noodles, wines, fruit juices, etc. In other words, different domains could have different ways of classification. In an embodiment, the experience value of critic level in each domain could not be counted in other domains. For example, in the database 130, the experience value of a user accumulated in the domain of Chinese cuisine restaurant would not affect the critic level in the domain of western cuisine restaurant. Whereby, the expertise and credibility of critics in different domains could be maintained.

It is worth mentioning that, in an embodiment, no matter it's one of the shops rating one of the buyers, or one of the buyers rating a service of a product of one of the shops, the virtual currency would be both required. Though each of the buyers has to pay a certain amount of virtual currency to rate a product or a service, the rating system of the present invention has something particular. Once a buyer rates the products or services in one domain for certain times, said buyer would become an expert level critic in said domain. The users who have the identity of expert level critic could take rating tasks for products or services on the task platform, while the shops could publish rating tasks for products and services on the task platform, wherein said rating tasks would provide a certain amount of virtual currency as rewards. In this way, the amount of virtual currency of said buyer could be increased, and the reputation of said shops could be enhanced as well. In other words, the rating mechanism is a win-win design.

The comments on the rating platform 160 could be viewed and therefore referred by other user ends. In an embodiment, other user ends could also leave a comment about whether the comment is useful or objective. In an embodiment, if other user ends mostly leave positive comments for one comment, then the user end which left said comment would accordingly receive more experience points as rewards. On the contrary, if other user ends mostly leave negative comments of one comment, which means that said comment might be not true or not correct, then the user end which left said comment would be accordingly punished, such as reducing the experience points which would be added to the experience value of critic level. In serious circumstances, said user could be even suspended to prevent incorrect comments from being spread.

With the critic level in the system becoming higher, the user would also collect certain experiences and expertise in a certain domain, and would even have followers and become famous. In an embodiment, as one of the shops 210, a user could invite critics to experience the products or services which are provided by said shop 210 by paying a certain amount of virtual currency and/or by providing the products or services for free to the critics. The invited critics would publish comments on the products or services provided by said shop 210 on the rating platform 160, which could be used as advertisements or propagandas to bring in more customers and revenues, for the buyers 220 (i.e., other user ends and the followers of the critics) would be attracted to purchase in said shop 210.

This shows, with the design of the rating platform 160, a user could invest themselves at the beginning by actively paying a certain amount of virtual currency and publishing ratings; at the same time, said user should also collect more experiences and expertise. After that, once the critic level of said user in the database 130 gradually becomes higher, said user would have chances to be invited by the shops and to earn generous rewards.

It is also worth mentioning that, about the invitations sent out by the shops 210 to invite critics in related domains, such operation could be also done by publishing tasks for critics on the aforementioned task platform 150, wherein the tasks could be taken by the helpers 230 (i.e., the critics) in the domain depending on their choices. Once any one of the tasks is completed, a corresponding payment would be made.

In an embodiment, the server end 100 further has an application established with a guiding platform (or called a guiding system) 170, wherein the guiding platform 170 has different usages for the shops 210, the buyers 220, and the helpers 230, which are described in details below.

For the shops 210, the guiding platform 170 provides the following services: when a buyer browses a shop on the electronic device, or physically enters the shop, the guiding platform 170 connected to the shop would actively introduce the products and services of the shop to the buyer, or notify the buyer of the current business condition of the shop, such as the number of people who have ordered meals, the estimated waiting time, the number of people who is still waiting in line, etc. Whereby, the function of having a virtual clerk guiding the shop could be accomplished.

For the buyers 220, the guiding platform 170 could provide the following services: when one buyer 220 is searching for products or services, helping the buyer 220 to quickly find products or services which meet the requirements. It is worth mentioning that, if the buyer 220 is interested in a product which requires bidding or has to be pre-ordered in a limited period, the guiding platform 170 could further provide a reminding function. In other words, if the period for the purchased product or service is about to end, the guiding platform 170 could actively remind the buyer 220 to avoid disappointments. In addition, the guiding platform 170 could be further connected to the rating platform 160, whereby related products or services could be retrieved out from the rating platform 160 to be recommended to the buyer 220 according to the searching conditions or searching history of the buyer 220. As a result, the buyer 220 would be more willing to buy, and the chances of selling things for the shops 210 could be increased as well.

For the helpers 230, the guiding platform 170 could provide the following services: setting schedules for the helper tasks taken by one of the helpers 230, and reminding said helper 230 about the deadlines and expected complete times of the helper tasks which are not completed yet. Furthermore, said helper 230 could be the first one to take a new task. In other words, once there is a new helper task published, said helper 230 could be the first one to take the task with the help of the guiding platform 170. However, such usage is not a limitation of the present invention.

It is also worth mentioning that, in an embodiment, obtaining the use permission of said guiding platform 170 would require an additional payment of the virtual currency, wherein the permissions of the guiding platform 170 related to the shops, the buyers, and the helpers could be respectively obtained to meet different requirements of the users.

In addition, shops compatible with the local service providing and service matchmaking system of the present invention are not limited to be restaurants. In practice, a user could also register at the server end 100 as a clothes shop, a home appliance store, a beverage store, a department store, a hotel, a leasing company (such as providing car rental, aircraft rental, charter service, etc.), a tour company, a Karaoke store, a cram school, a tutor, etc. In other words, the local service providing and service matchmaking system of the present invention could be applied in all businesses covering food, clothing, housing, transportation, education, entertainment.

In another embodiment, the differences from the above-mentioned embodiments are that, a user could register as a hotel or other types of accommodations in the lodging industry, and could upload related information to the database 130, wherein said information includes photos of the hotel, characteristics of each room, equipment in each room, total number of rooms, availability of foreign language services, availability of entertaining services (such as Karaoke, SPA, gym, etc.), check-in and check-out time, room cleaning time, fees for weekdays or holidays, activities for certain holidays, recommendations of other customers, etc., which could be browsed by other users (i.e., other buyers 220). The present invention mainly aims to the behaviors of matchmaking and trading in a certain region. Therefore, though the information of said hotel could be viewed by other users, booked services such as accommodating or dining would be canceled if the one who booked the services fails to enter a related region by a predetermined time. In addition, said shop could also communicate with buyers or introduce the hotel to buyers through a chatroom or the function of instant messaging. Furthermore, some specific questions could be stored in the database 130 as frequent Q&As. When one buyer inquiries the same or similar questions, the shop could retrieve the frequent Q&As as responses, which enhances the efficiency of communication. Moreover, after the shop and the buyer making their trading, the shop could also rate the buyer in the system. For example, said rating could be: (1) welcomed, where certain amount of virtual currency could be given to the buyer to improve the good feeling between both sides, and to encourage the buyer to visit again; (2) unwelcomed, where the buyer could be further noted as an unwelcomed customer or added to a block list, which prevents the buyer from getting any information related to the shop through the system. Similar to the aforementioned embodiments, the buyer could also search for hotels which meet their requirements through the matchmaking platform 140, or look for a helper to complete the task of trading through the task platform 150, or leave the experience of services or rate through the rating platform 160, or be invited to be a member of the hotel through a member system established by the hotel.

In another embodiment, the differences from the above-mentioned embodiments are that, a user could register as a shop in the transportation industry (e.g., a taxi), and could upload related information to the database 130, wherein said information includes photos of the taxi (or other transportation vehicles), characteristics of equipment (such as the availability of child safety seats, Karaoke, etc.), number of seats, specifications of the trunk, availability of foreign language services, availability of delivery services. Upon receiving bookings from passengers, the processing module 110 at the server end 100 could plan a route according to the pick-up locations and the destinations of the passengers, so that the taxi driver (i.e., the shop) could pick up passengers one by one along an optimized route, which provides a better efficiency. In addition, through the system, a passenger (i.e., a buyer) could provide information such as the pick-up location and time, the destination, the arriving time, the designated route, the number of people, whether accepting carpooling, etc. Furthermore, if the passenger accepts carpooling, a discount could be provided. After the taxi driver and the passenger make their trading, they could also rate each other in the system. For example, the taxi driver could rate the passenger as welcomed or not welcomed to take the taxi again. The taxi driver could even reject to accept the booking from the passenger in the future. On the other hand, the passenger could rate the taxi driver as excellent or poor, and could even refuse to take the taxi again. Also, in the transportation industry, a member system could be also established to invite passengers to join the membership, wherein the members could enjoy the priority of booking, discounts, birthday gifts, etc.

It must be pointed out that the embodiments described above are only some preferred embodiments of the present invention. All equivalent structures and methods which employ the concepts disclosed in this specification and the appended claims should fall within the scope of the present invention.

What is claimed is:

1. A local service providing and service matchmaking system, adapted to connect with
a plurality of user ends, comprising:
a processing module □
a communication module, connected to the processing module and adapted to communicate with the plurality of user ends to receive or respond the information or a service request uploaded by the plurality of user ends;
a database, connected to the processing module and adapted to store the information received by the communication module;
a matchmaking platform, connected to the processing module and adapted to match the service request uploaded by one of the plurality of user ends with the information stored in the database so as to generate and respond a matching result to the at least one of the plurality user ends; and
a task platform, connected to the processing module and adapted to publish at least one task based on the service request uploaded by the at least one of the plurality of user ends, wherein the at least one task can be selected by the at least one of the plurality of user ends registered as a helper to meet the service request, and the helper is rewarded after completing the at least one task.

2. The local service providing and service matchmaking system of claim 1, further comprising a rating platform connected to the processing module, the rating platform being executed to leave ratings by both sides of the service request met between the at least one of the plurality of user ends and the helper.

3. The local service providing and service matchmaking system of claim 1, wherein the at least one task comprises a rating task of a service request for rating a product or a service of a specific field; only when the helper accumulates a predetermined amount of rating experiences corresponding to the product or the service of the specific field, the helper can take the rating task of the specific field.

4. The local service providing and service matchmaking system of claim 1, wherein the at least one task can be taken or searched by the helper is the tasks located in a predetermined region around a location of the helper.

5. The local service providing and service matchmaking system of claim 4, wherein the predetermined region enlarges with the number of the tasks completed by the helper.

6. The local service providing and service matchmaking system of claim 1, wherein the at least one task comprises a task for deliver service; the task for deliver service has a setting of an origin and a destination of delivery; a helper who is located within a predetermined region around the origin or the destination of delivery can take the task for deliver service.

7. The local service providing and service matchmaking system of claim 1, wherein the service request comprises spreading an activity of a group buy to other user ends located in a region.

8. The local service providing and service matchmaking system of claim 1, wherein the information uploaded by the plurality of user ends further comprises a virtual sheet including a plurality of virtual keys; each of the plurality of virtual keys is connected to a corresponding object; the virtual sheet is generated by the processing module through image identification with a sheet image retrieved from taking a picture of a sheet.

9. The local service providing and service matchmaking system of claim 8, wherein a predetermined area is selected by one of the plurality of user ends, and the virtual menu is generated according to an object included in the predetermined area.

10. A method for providing local service and service matchmaking, comprising:
receiving and storing information uploaded from a plurality of user ends in a database;
providing a matchmaking platform adapted to receive a service request uploaded by at least one of the plurality of user ends, and match the service request and the information stored in the database so as to generate and respond a matching result to the at least one of the plurality user ends;
providing a task platform adapted to receive the service request uploaded by the at least one of the plurality of user ends, and publish at least one task according to the service request;
receiving a selection of the at least one task from the at least one of the plurality of helpers registered as a helper, and rewarding the helper after the service request of the at least one task being met by the helper.

11. The method for providing local service and service matchmaking of claim 10, further comprising providing a rating platform adapted to being executed to leave ratings by both sides of the service request met between the at least one of the plurality of user ends and the helper.

12. The method for providing local service and service matchmaking of claim 10, wherein the at least one task comprises a rating task which is a service request for rating a product or a service of a specific field; only when the helper accumulates a predetermined amount of rating experiences corresponding to the product or the service of the specific field, the helper can take the rating task of the specific field.

13. The method for providing local service and service matchmaking of claim 10, wherein the at least one task which can be taken or searched by the helper is the tasks located in a predetermined region around a location of the helper.

14. The method for providing local service and service matchmaking of claim 13, wherein the predetermined region enlarges with the number of the tasks completed by the helper.

15. The method for providing local service and service matchmaking of claim 10, wherein the at least one task comprises a task for deliver service; the task for deliver service has a setting of an origin and a destination of delivery; a helper who is located within a predetermined region around the origin or the destination of delivery can take the task for deliver service.

16. The method for providing local service and service matchmaking of claim 10, wherein the service request comprises spreading an activity of a group buy to other user ends located in a region.

17. The method for providing local service and service matchmaking of claim 10, wherein the information uploaded by the plurality of user ends further comprises a virtual sheet including a plurality of virtual keys; each of the plurality of virtual keys is connected to a corresponding object; the virtual sheet is generated by the processing module through image identification with a sheet image retrieved from taking a picture of a sheet.

18. The method for providing local service and service matchmaking of claim 10, wherein a predetermined area is selected by one of the plurality of user ends, and the virtual menu is generated according to an object included in the predetermined area.
